(19) United States
(12) Patent Application Publication
(10) Pub. No.: US 2017/0325018 A1
(43) Pub. Date: Nov. 9, 2017

(54) ACOUSTIC BAFFLE

(71) Applicant: Jaguar Land Rover Limited, Coventry, Warwickshire (GB)

(72) Inventor: Ashutosh Tomar, Coventry, Warwickshire (GB)

(21) Appl. No.: 15/528,904

(22) PCT Filed: Dec. 15, 2015
(86) PCT No.: PCT/EP2015/079747

§ 371 Date: May 23, 2017

(30) Foreign Application Priority Data
Dec. 15, 2014 (GB) 1422275.6

(51) Int. Cl. H04R 1/28

(52) U.S. Cl. CPC H04R 1/2811; H04R 1/2873; H04R 2499/13

(57) ABSTRACT

The present disclosure relates to an acoustic baffle (2) for attenuating sound waves generated by an acoustic source (3). The acoustic baffle (2) is made up of one or more cells (8). The cells (8) each have opposing first and second walls (11, 12) defining at least one resonator chamber (9) for attenuating sound waves generated by the acoustic source (3). The first wall (11) has an inlet aperture (16) for ingress of sound waves generated by the acoustic source into the resonator chamber (9); and the second wall (12) has an outlet aperture (17) for egress of attenuated sound waves from the resonator chamber (9). The present disclosure also relates to an audio transducer assembly (3) including an acoustic baffle (2). Furthermore, the present disclosure relates to a vehicle including an acoustic baffle (2).

### TECHNICAL FIELD

The present disclosure relates to an acoustic baffle, to an audio transducer assembly and to a vehicle comprising an acoustic baffle.

### BACKGROUND

It is known to provide loudspeaker assemblies, such as woofers and subwoofers, with a baffle system to isolate out of phase acoustic signals or to reverse the phase of acoustic signals produced from the back of the audio transducer. These baffle systems typically require a relatively large internal volume. This is potentially problematic in the automotive industry where space is limited.

It is against this backdrop that the present invention has been conceived. At least in certain embodiments, the present invention relates to an acoustic baffle which overcomes or ameliorates at least some of the shortcomings associated with prior art baffle systems.

### SUMMARY OF THE INVENTION

Aspects of the present invention relate to an acoustic baffle, to an audio transducer and to a vehicle comprising an acoustic baffle.

According to a further aspect of the present invention there is provided an acoustic baffle for attenuating sound waves generated by an acoustic source, the acoustic baffle comprising:
one or more cells each comprising:
   opposing first and second walls defining at least one resonator chamber for attenuating sound waves generated by the acoustic source;
   the first wall comprising an inlet aperture for ingress of sound waves generated by the acoustic source into the resonator chamber; and
   the second wall comprising an outlet aperture for egress of attenuated sound waves from the resonator chamber.

The acoustic baffle can comprise one or more resonator chambers which function as one or more acoustic resonator for attenuating sound waves transmitted through the acoustic baffle, thereby reducing acoustic pressure. In certain embodiments, the acoustic resonator can be a Helmholtz resonator.

The one or more resonator chamber can be configured to filter a predefined audio frequency or a range of audio frequencies. At least in certain embodiments, the acoustic baffle can be configured to attenuate sound waves in a predetermined frequency range whilst facilitating the transmission of sound waves outside this range. The acoustic baffle can permit the passage of air through the one or more cells.

The first and second walls define opposing surfaces of said at least one resonator chamber. The first wall can be arranged to face the acoustic source. The second wall can be arranged to face away from the acoustic source. Thus, sound waves can enter the at least one resonator chamber through the inlet aperture, travel through the at least one resonator chamber and exit through the outlet aperture.

The one or more cells could each have a single inlet aperture and/or a single outlet aperture. Alternatively, each cell can comprise more than one inlet aperture and/or more than one outlet aperture.

An acoustic pathway is formed through each cell between said inlet aperture and said outlet aperture. The inlet aperture forms an inlet to said acoustic pathway and the outlet aperture forms an outlet from said acoustic pathway. The acoustic pathway can open into the at least one resonator chamber. The acoustic pathway can be formed through a plurality of said cells.

At least one internal wall can extend between said first and second walls. The at least one internal wall can define a plurality of said resonator chambers. The resonator chambers can be disposed adjacent to each other. For example, the resonator chambers can be arranged in a side-by-side configuration.

Each cell can comprise first and second internal walls. The first and second walls can be inclined at an angle relative to each other. The first and second internal walls can, for example, be arranged substantially perpendicular to each other. The first internal wall can be in the form of a part-circular or arcuate wall, for example having a centre of curvature disposed on a longitudinal axis of the acoustic baffle. The second internal wall can be in the form of a radial wall.

An opening can be formed in each internal wall to establish communication between two or more of said resonator chambers. The opening can be aligned with said inlet aperture and/or said outlet aperture such that said resonator chambers are in communication with the inlet aperture and/or the outlet aperture.

The first and second walls can be arranged substantially parallel to each other. For example, the first and second walls can be arranged perpendicular to a central axis of the acoustic baffle. Alternatively, the first and second walls can be arranged concentrically about a central axis of the acoustic baffle.

The first and second walls can have substantially matching profiles. The first and second walls can be substantially planar. Alternatively, the first and second walls can be non-planar, for example having a curved or arcuate form. The first and second walls can be concentric curved walls.

The acoustic baffle can comprise a plurality of said cells. The cells could be arranged in a single layer. Alternatively, the cells can be arranged in multiple layers, for example in a 3-dimensional array. The acoustic baffle can have a multi-layered arrangement. The layers forming the acoustic baffle can be arranged contiguously. Adjacent layers can be contiguous such that the cells in the layers are juxtaposed. The cells in adjacent layers can be arranged such that the outlet from a cell in a first layer opens into the inlet of a cell in a second layer.

Each layer can be substantially planar. Alternatively, each layer can be non-planar, for example curved or arcuate. Each layer can be curved, for example curved about an axis to form a cylinder or a part-cylinder. The cylindrical layer can, for example, be in the form of a right cylinder. A plurality of said cylindrical layers can be arranged concentrically about a central axis of the acoustic baffle. In a variant, each layer can be curved in more than one plane, for example to form a portion of a sphere. Each layer can be in the form of a polygonal surface.

The inlet aperture and the outlet aperture can be aligned with each other in the respective first and second walls. This arrangement can establish a linear acoustic pathway through the acoustic baffle, for example when several acoustic chambers are arranged in a series. Alternatively, the inlet aperture and the outlet aperture can be offset from each other in the respective first and second walls. This arrangement can establish a serpentine or labyrinthine acoustic pathway through the acoustic baffle. The acoustic baffle can comprise two or more layers of said cells.

The opposing first and second walls can have planar profiles which are arranged substantially parallel to each other. Alternatively, the opposing first and second walls can have matching non-planar profiles. The first and second walls can, for example, be curved.

The cells can each be elongated along a longitudinal axis. The longitudinal axis can be linear. Each cell can be in the form of a polyhedron, for example a rectangular cuboid. Moreover, the at least one resonator chamber can be in the form of a polyhedron, for example a rectangular cuboid. The cells can be arranged in a geometric pattern about a central axis of the acoustic baffle. The acoustic baffle can be in the form of a polyhedron, for example a rectangular cuboid. Alternatively, the acoustic baffle can be in the form of a dome or an oval.

Alternatively, the longitudinal axis can be curved, for example to form a curved or arcuate cell. Each cell can have a part-circular form and the cells can be arranged to form an acoustic baffle having a circular or part-circular transverse section. For example, the cells can be arranged to form an acoustic baffle having a cylindrical or part-cylindrical shape. The acoustic baffle can, for example, be in the shape of a right cylinder. The direction of travel of the sound waves through the resonator chambers (as determined by the acoustic pathway defined within the acoustic baffle) can be substantially parallel to a central axis of the acoustic baffle. Alternatively, the direction of travel of the sound waves through the resonator chambers (as determined by the acoustic pathway defined within the acoustic baffle) can be substantially perpendicular to a central axis of the acoustic baffle.

Alternatively, each cell can have a part-conical form and the cells can be arranged to form at least a portion of a cone. The direction of travel of the sound waves through the resonator chambers (as determined by the acoustic pathway defined within the acoustic baffle) can be inclined at an angle relative to a central axis of the acoustic baffle.

Alternatively, each cell can have a part-spherical form and the cells can be arranged to form at least a portion of a sphere, for example to form a hemispherical array. The direction of travel of the sound waves through the resonator chambers (as determined by the acoustic pathway defined within the acoustic baffle) can be radially outwardly from a reference point in the acoustic baffle.

The cells can be arranged concentrically about said central axis. An internal volume of a resonator chamber proximal to the central axis can be smaller than an internal volume of a resonator chamber distal from said central axis. The internal volume of the resonator chambers can increase with radial distance from the central axis. Alternatively, the cells can be configured such that the internal volume of the resonator chambers is at least substantially the same irrespective of the position of the resonator chamber within the acoustic baffle.

The outlet aperture of at least one of said acoustic chambers can be open to atmosphere. For example, each cell disposed distal to the acoustic source can comprise an outlet aperture which is open to atmosphere.

The at least one resonator chamber is hollow. A sound damping material can be provided in said at least one resonator chamber. The sound damping material can, for example, comprise a foam material. The acoustic chamber can be at least partially filled with the sound damping material. In use, the acoustic chamber can function as a sound dampener. The acoustic baffle can comprise a plurality of resonator chambers, at least one of said resonator chambers can be unfilled and at least one of said resonator chambers can be partially or completely filled with the sound damping material.

According to a further aspect of the present invention there is provided an acoustic baffle for attenuating sound waves generated by an acoustic source, the acoustic baffle comprising:
one or more cells each comprising:
   opposing first and second walls and at least one internal wall extending between said first and second walls to define two or more resonator chambers for attenuating sound waves generated by the acoustic source;
   the first wall comprising an inlet aperture for ingress of sound waves generated by the acoustic source into the resonator chamber;
   the second wall comprising an outlet aperture for egress of attenuated sound waves from the resonator chamber; and wherein
   said first and second walls are concentric curved walls, and at least two of said two or more resonator chambers have different internal volumes.

According to a further aspect of the present invention there is provided an audio transducer assembly comprising an audio transducer and an acoustic baffle as described herein. The first wall of the acoustic baffle can be arranged to face the audio transducer and the second wall of the acoustic baffle can be arranged to face away from the audio transducer.

A cavity can be disposed between the audio transducer and the acoustic baffle to provide a working volume for the audio transducer. The cavity can be open to atmosphere only through the acoustic baffle. The cavity can be defined by a sidewall, for example a cylindrical sidewall. The cavity provides a working volume for the acoustic transducer.

The audio transducer and the acoustic baffle can be arranged coaxially within the audio transducer assembly.

The audio transducer can comprise a diaphragm for generating sound waves. The diaphragm can be arranged to interact with a voice coil. The voice coil can comprise an electromagnet for generating a varying magnetic field to induce vibrations in the diaphragm. A permanent magnet can be mounted to the diaphragm for interaction with said voice coil. The diaphragm can be a cone or a truncated cone, for example comprising a nylon or paper-based membrane.

The diaphragm can have a front face and a back face. The acoustic baffle can be disposed behind the audio transducer. The first wall of the acoustic baffle can be arranged to face the back face of the diaphragm. The second wall of the acoustic baffle can be arranged to face away from the audio transducer.

The diaphragm and the acoustic baffle can have substantially the same outer diameter.

The audio transducer can be in the form of a loudspeaker. The audio transducer assembly can be a woofer or a subwoofer.

According to a further aspect of the present invention there is provided a vehicle having an acoustic baffle as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying Figures, in which:

FIG. 1 shows a sectional view along a dimensional plane of an audio transducer assembly incorporating an acoustic baffle in accordance with an embodiment of the present invention;

FIG. 2 shows a plan view of the acoustic baffle shown in FIG. 1;

FIG. 3 shows a semi-transparent perspective view of a cell of the acoustic baffle shown in FIG. 1;

FIG. 4 shows a schematic representation of the alignment of the cells in the acoustic baffle shown in FIG. 1;

FIG. 5A shows the modeled acoustic pressure at a first operating frequency for an audio transducer assembly without an acoustic baffle;

FIG. 5B shows the modeled acoustic pressure at the first operating frequency for an audio transducer assembly incorporating the acoustic baffle shown in FIG. 1;

FIG. 6A shows the modeled acoustic pressure at a second operating frequency for an audio transducer assembly without an acoustic baffle;

FIG. 6B shows the modeled acoustic pressure at the second operating frequency for an audio transducer assembly incorporating the acoustic baffle shown in FIG. 1;

FIG. 7 shows a comparison of the measured sound pressure level in front of and behind the acoustic baffle shown in FIG. 1;

FIG. 8 shows a graph representing the transmission loss across the acoustic baffle across a range of operating frequencies;

FIG. 9 shows a modified arrangement of the acoustic baffle defining a serpentine acoustic pathway;

FIG. 10 shows an alternate cell structure consisting of two resonator chambers bisected by an internal wall;

FIG. 11 shows an alternate cell structure consisting of one resonator chamber;

FIG. 12 shows a plan view of a modified arrangement of the acoustic baffle in accordance with an embodiment of the present invention;

FIG. 13 shows a perspective view of a series of cells making up the acoustic baffle shown in FIG. 12;

FIG. 14 shows a first alternative configuration of a cell for the second embodiment of the present invention; and

FIG. 15 shows a second alternative configuration of a cell for the second embodiment of the present invention.

### DETAILED DESCRIPTION

An audio transducer assembly 1 comprising an acoustic baffle 2 and an audio transducer 3 in accordance with an embodiment of the present invention will now be described with reference to the accompanying Figures. The acoustic baffle 2 in the present embodiment is configured to attenuate sound waves in the frequency range 20 Hz to 1 kHz. The audio transducer assembly 1 has particular application in an automotive vehicle, for example forming part of an audio system to generate sound waves within an occupant compartment of the vehicle.

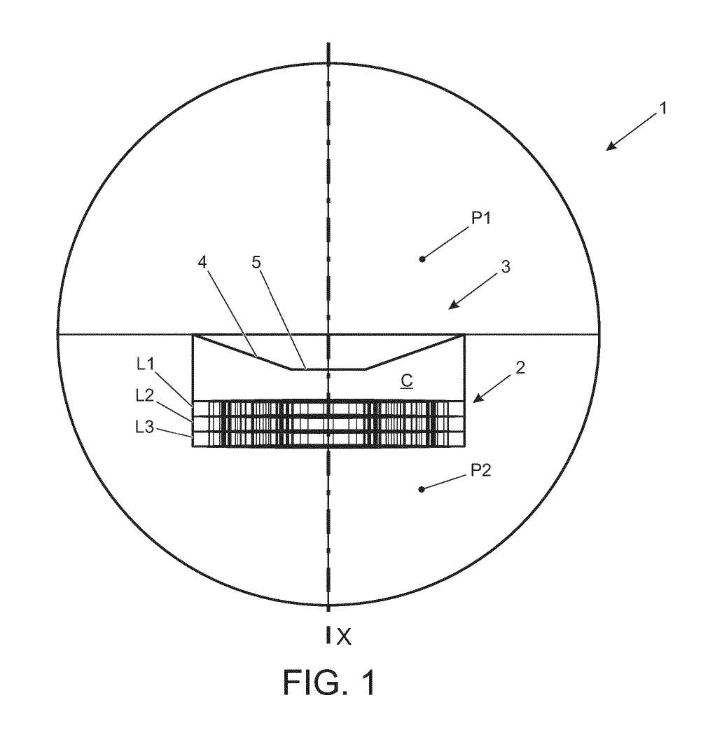

In the present embodiment, the audio transducer 3 is in the form of a loudspeaker having a metal casing (not shown) which supports a diaphragm 4 and a permanent magnet 5. The diaphragm 4 is cone-shaped and has an outer diameter of 150mm. The diaphragm 4 is made of a semi-rigid nylon membrane adapted to support the permanent magnet 5. In use, the permanent magnet 5 interacts with a voice coil (not shown) to cause the diaphragm 4 to vibrate thereby generating sound waves. The diaphragm 4 has a forward-facing front face 6 and a rearward-facing back face 7. The audio transducer 3 is arranged such that the sound waves generated at the front face 6 are directed towards a listener, for example in to the occupant compartment of a vehicle. As shown in FIG. 1, the acoustic baffle 2 is disposed behind the audio transducer 3 to dampen the sound waves generated at the back face 7. A cavity C is defined between the acoustic baffle 2 and the audio transducer 3 to provide a working volume for the audio transducer 3.

The acoustic baffle 2 comprises a plurality of cells 8 each consisting of four resonator chambers 9. The resonator chambers 9 are hollow and, as described herein, function as an acoustic resonator (which can be a Helmholtz resonator) for attenuating sound waves transmitted through the acoustic baffle 2. As shown in FIG. 1, in the present embodiment the acoustic baffle 2 is multi-layered and comprises three layers L1-3 each comprising a plurality of said cells 8. The acoustic baffle 2 is formed from acrylic and can be moulded (for example by moulding each layer L1-3 separately) or formed using a 3-dimensional printing technique. The cells 8 each have a part-cylindrical (arcuate) form and are arranged in a cylindrical configuration about a central circular region 10. The central circular region 10 aligns with the permanent magnet 5 of the audio transducer 3 and is closed to inhibit transmission of sound waves. The closed circular region 10 can provide a mounting platform for the voice coil of the audio transducer 3. The layers L1-3 are arranged coaxially along a longitudinal axis X such that an outer profile of the acoustic baffle 2 forms a right cylinder. The thickness of each layer L1-3 of the acoustic baffle 2 is approximately 5 mm (measured along the longitudinal axis X) and the acoustic baffle 2 has a diameter of 150 mm. The cells 8 in each layer L1-3 have the same arrangement and only the first layer L1 will be described for brevity.

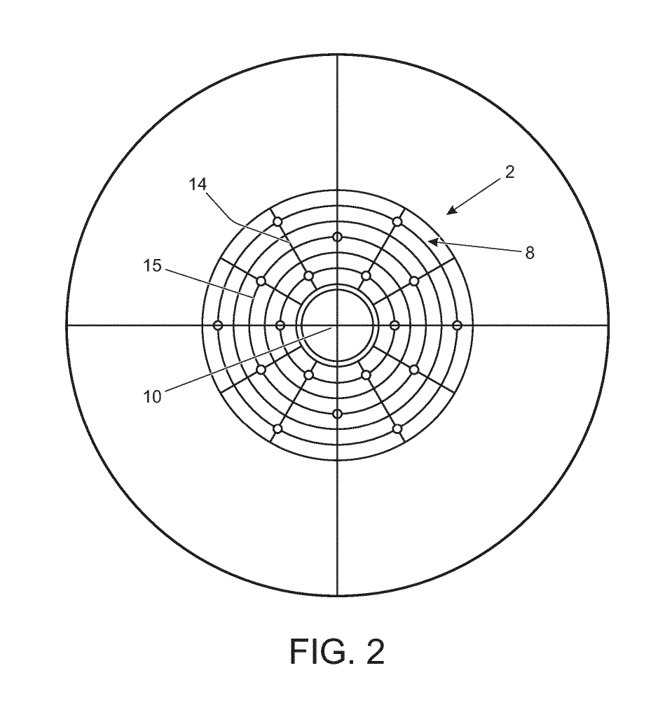

The cells 8 in the first layer L1 are defined between opposing first and second walls 11, 12 which extend perpendicular to the longitudinal axis X. In the present embodiment, the first and second walls 11, 12 are planar walls arranged substantially parallel to each other. As illustrated in FIG. 2, a series of internal walls 13 are formed between the first and second walls 11, 12 to form the cells 8 and the resonator chambers 9. The internal walls 13 comprise radial walls 14 and concentric circular walls 15. In the present embodiment, there are twelve radial walls 14 (having an angular spacing of 30°), and seven circular walls 15 which are evenly spaced in a radial direction. A plurality of inlet apertures 16 are formed in the first wall 11; and a plurality of outlet apertures 17 are formed in the second wall 12. The inlet and outlet apertures 16, 17 establish an acoustic pathway for transmission of sound waves through the cells 8. In the present embodiment, the inlet and outlet apertures 16, 17 have a diameter of 5 mm. The first wall 11 faces the diaphragm 4 such that the inlet apertures 16 enable ingress of sound waves into the resonator chambers 9. The second wall 12 faces away from the diaphragm 4 to enable egress of at least partially attenuated sound waves from the resonator chambers 9. The resonator chambers 9 can be configured to reduce or filter an audio component of sound waves at least in a given frequency range. For example, the internal volume of the resonator chambers 9 can be configured to filter sound waves having a particular frequency or a within a particular frequency range.

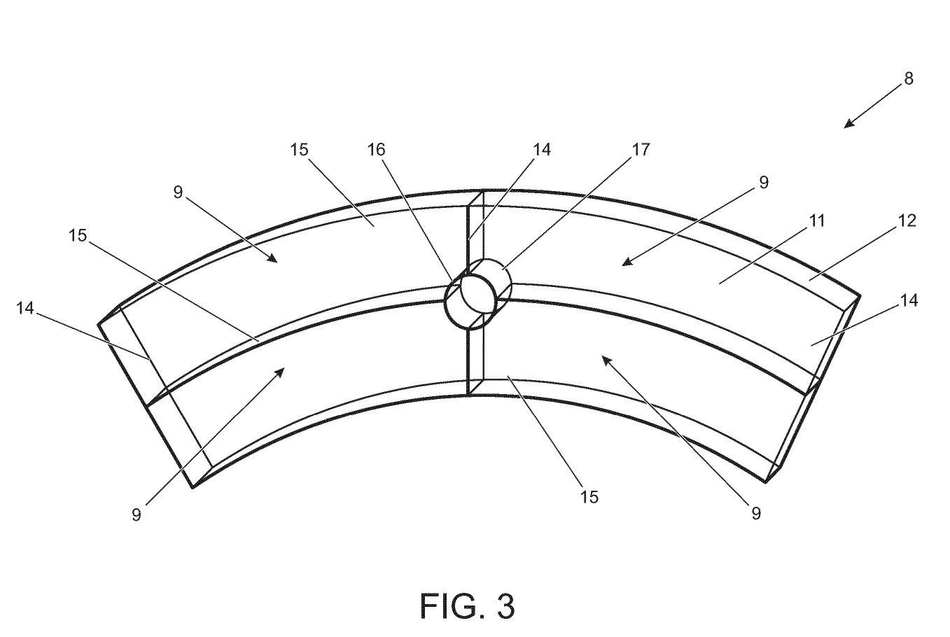

A partially-transparent perspective view of one of the cells 8 is shown in FIG. 3. The cell 8 is symmetrical about a radial centre line (which is coincident with the radial wall 14 disposed in the centre of the cell 8). It will be appreciated that, due to the geometry of the acoustic baffle 2, the radially outer resonator chambers 9 have a larger internal volume than the radially inner resonator chambers 9. Thus, the radially inner and outer resonator chambers 9 making up each cell 8 have different internal volumes. Moreover, the resonator chambers 9 in the radially inner cells 8 have a small internal volume than those in the radially outer cells 8. The internal volumes of the resonator chambers 9 can be tuned to attenuate sound waves having different frequencies. The inlet and outlet apertures 16, 17 are positioned in the first and second walls 11, 12 within adjacent cells 8 at the intersection of the radial and circular walls 14, 15. Thus, each inlet aperture 16 and each outlet aperture 17 open directly into the four resonator chambers 9 making up that cell 8. An opening is formed in the radial and circular walls 14, 15 coincident with the inlet and outlet apertures 16, 17 to establish communication between each of the resonator chambers 9. The inlet and outlet apertures 16, 17 thereby form an acoustic pathway for transmitting sound waves through the cell 8.

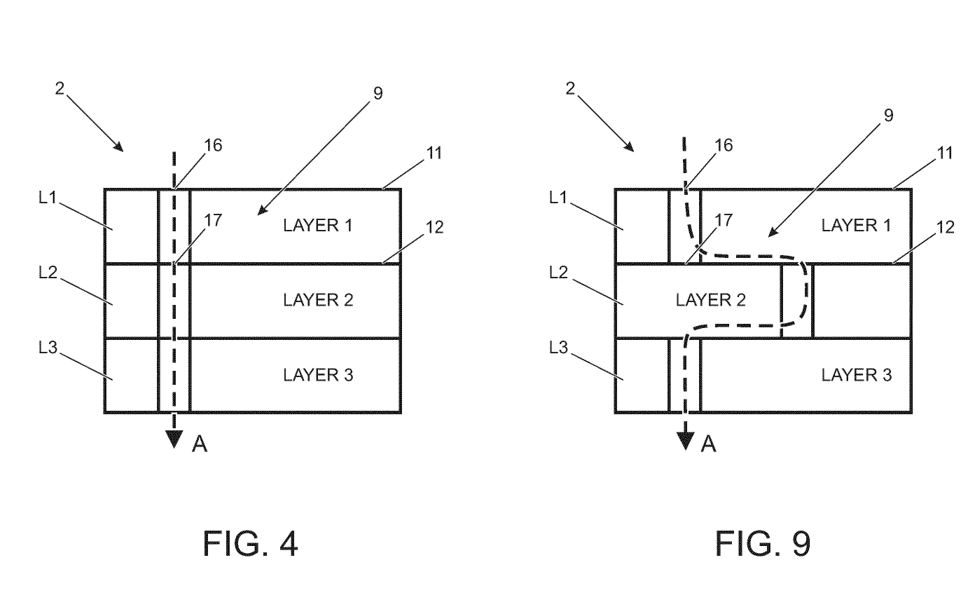

A sectional view of a portion of the acoustic baffle 2 is shown in FIG. 4. The layers L1-3 are arranged such that the inlet apertures 16 and the outlet apertures 17 are aligned with each other. Thus, a linear acoustic pathway (illustrated by the Arrow A in FIG. 4) is established through the cells 8 aligned with each other in the acoustic baffle 2.

The operation of the audio transducer assembly 1 will now be described. In use, the voice coil in the audio transducer 3 is energized to cause the diaphragm 4 to vibrate and to generate sound waves. The sound waves generated at the front face 6 of the diaphragm 4 are directed towards a listener. However, the sound waves generated at the back face 7 of the diaphragm 4 are out of phase and could potentially affect the quality of the audio signal generated by the audio transducer assembly 1. The acoustic baffle 2 is disposed behind the audio transducer 3 to attenuate the sound waves generated by the back face 7. In use, the generated sound waves enter the cells 8 in the first layer L1 through the inlet apertures 16 disposed in the first wall 11. The resonator chambers 9 function as acoustic resonators for attenuating the sound waves as they are transmitted through the acoustic baffle 2. The attenuated sound waves exit the resonator chambers 9 in the first layer L1 through the outlet apertures 17 in the second wall 12. The attenuation of the sound waves continues as the sound waves are transmitted through the cells 8 in the second and third layers L2, L3. The outlet apertures 17 in the third layer L3 are open to atmosphere.

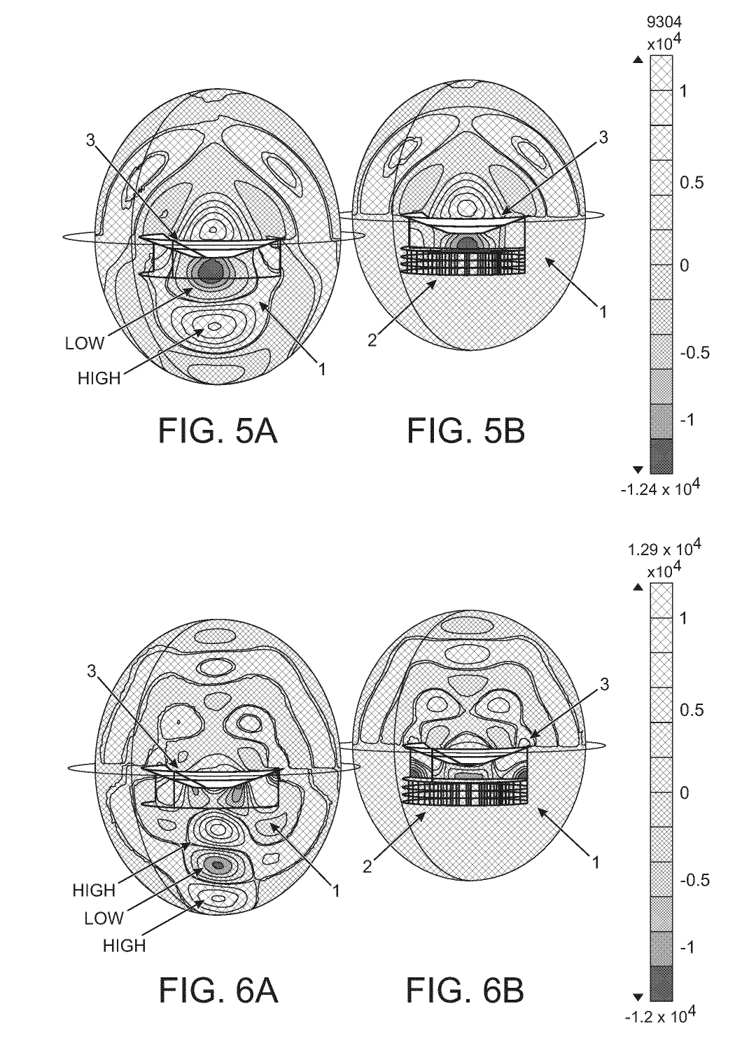

As outlined above, the resonator chambers 9 making up the acoustic baffle 2 have different internal volumes, thereby ensuring that sound waves having a range of frequencies are damped. The acoustic pressure surrounding the audio transducer 3 at an operating frequency of 4000 Hz is illustrated in FIGS. 5A and 5B. The audio transducer assembly 1 is shown in FIG. 5A with the acoustic baffle 2 omitted. A high pressure region HIGH and a low pressure region LOW are established behind the audio transducer 3 by the sound waves generated at the back face 7 of the diaphragm 4. The audio transducer assembly 1 is shown in FIG. 5B with an acoustic baffle 2 in accordance with an embodiment of the present invention. The acoustic baffle 2 attenuates the sound waves generated at the back face 7 of the diaphragm 4 which results in a lower acoustic pressure behind the audio transducer 3.

The acoustic pressure surrounding the audio transducer 3 at an operating frequency of 6000 Hz is illustrated in FIGS. 6A and 6B. The audio transducer assembly 1 is shown in FIG. 6A with the acoustic baffle 2 omitted. A high pressure region HIGH is established between two low pressure regions LOW in the region behind the audio transducer 3. The audio transducer assembly 1 is shown in FIG. 6B with the acoustic baffle 2 in place. Again, the acoustic pressure behind the audio transducer 3 is lower when the acoustic baffle 2 is installed.

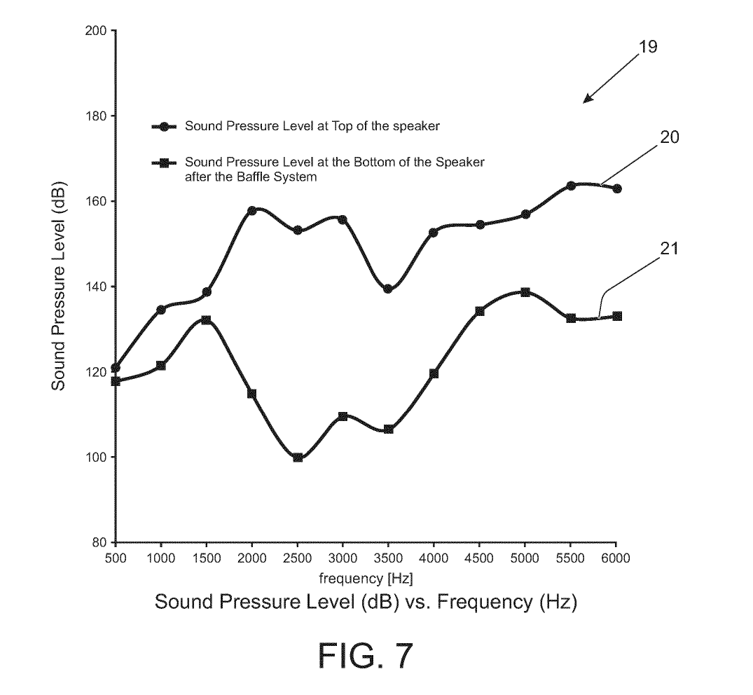

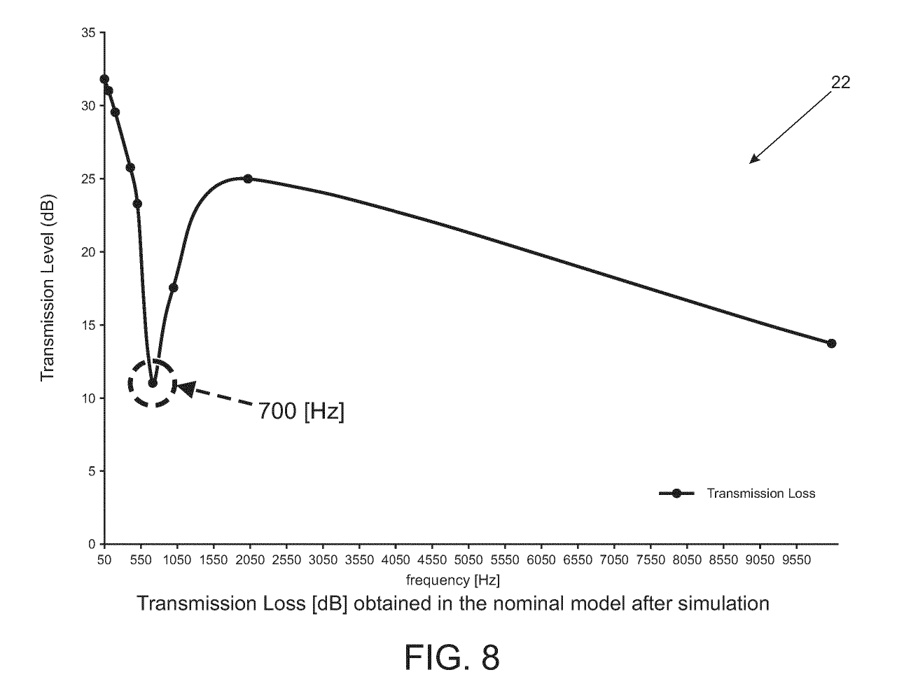

A first graph 19 representing the measured sound pressure level (dB) against frequency (Hz) between 500 Hz and 6000 Hz is shown in FIG. 7. A first plot 20 shows the sound pressure level measured at a first position P1 disposed in front of the acoustic baffle 2 and the audio transducer 3. A second plot 21 shows the sound pressure level measured at a second position P2 behind the acoustic baffle 2. A second graph 22 representing the transmission loss (dB) against frequency (Hz) between 50 Hz and 10000 Hz is shown in FIG. 8.

A sectional view through an alternative arrangement of the audio transducer 2 is shown in FIG. 9. The inlet and outlet apertures 16, 17 are offset from each other to form a serpentine acoustic pathway (illustrated by the Arrow A in FIG. 9) through the cells 8 in each layer L1-3. The serpentine acoustic pathway can be defined in two dimensions through a plurality of said resonator chambers 9, for example an S-shaped pathway. Alternatively, the serpentine acoustic pathway can be defined in three dimensions through a plurality of said resonator chambers 9, for example a helical pathway extending through the acoustic baffle 2.

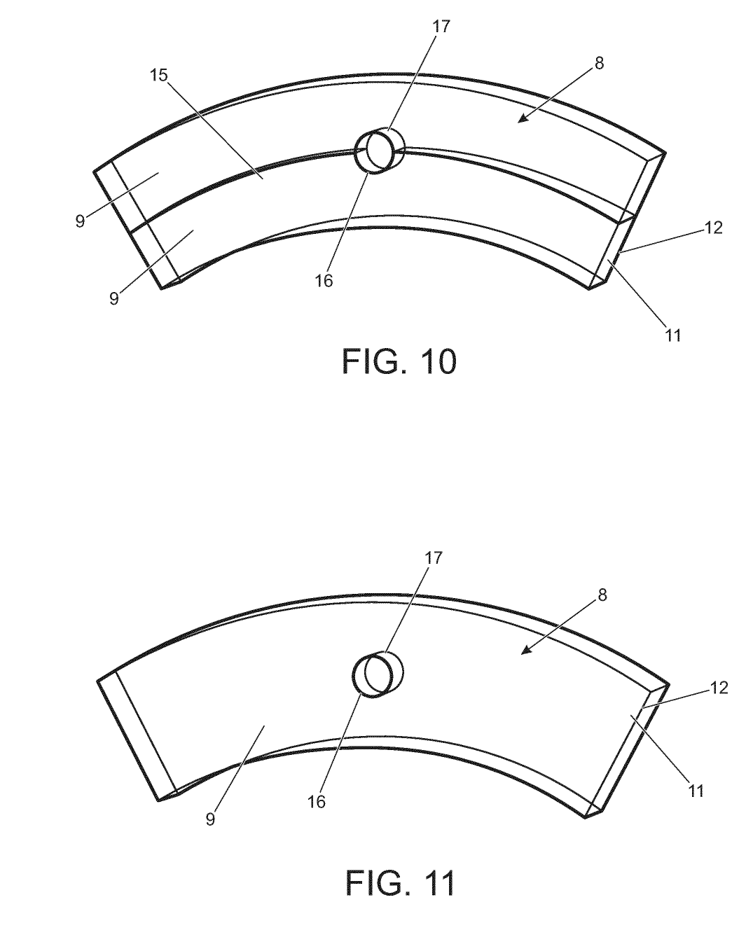

A further modified arrangement is illustrated in FIG. 10 in which the cells 8 each consist of two resonator chambers 9. In this arrangement the circular wall 15 bisects the cell 8 to form the resonator chambers 9. The inlet and outlet apertures 16, 17 are formed in the centre of the first and second walls 11, 12 to communicate with both of the resonator chambers 9.

A further modified arrangement is illustrated in FIG. 11 in which the cells 8 each consist of a single resonator chamber 9. In this arrangement the radial and circular walls 14, 15 define the outer perimeter of the cell 8. The inlet and outlet apertures 16, 17 are formed in the centre of the first and second walls 11, 12 to provide an acoustic pathway into the centre of the resonator chamber 9.

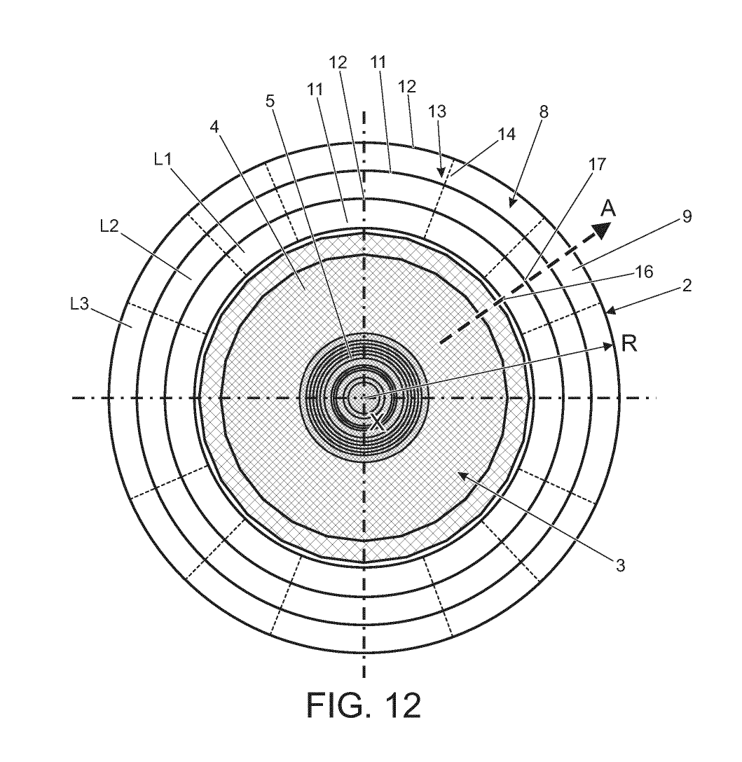

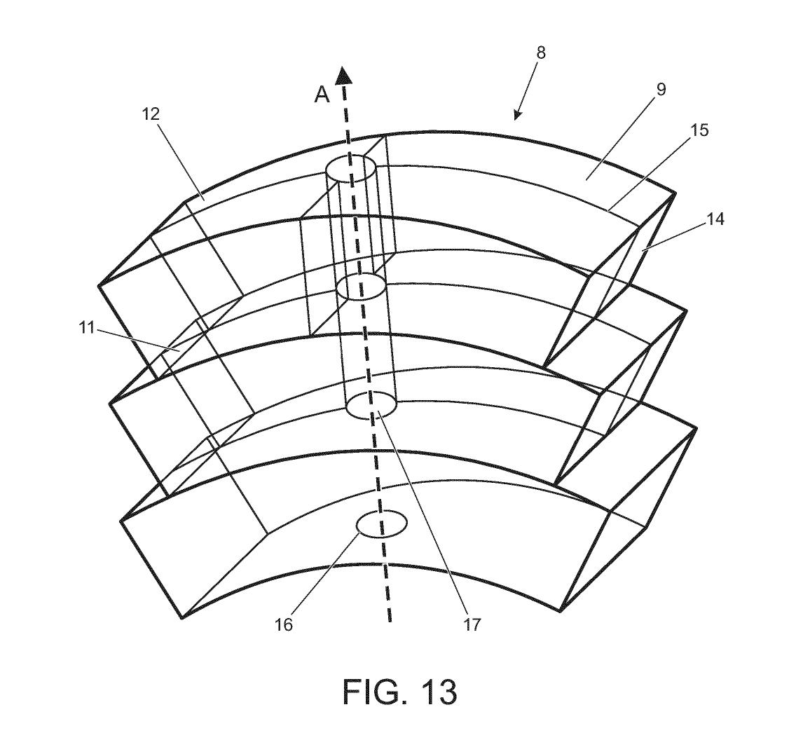

A further modified arrangement of the acoustic baffle 2 will now be described with reference to FIGS. 12 and 13. Like reference numerals are used for like components. In this arrangement, the cells 8 are disposed in cylindrical layers arranged concentrically about a longitudinal axis X of the audio transducer 3. Thus, the acoustic baffle 2 has a generally annular configuration and the cells 8 are arranged to establish a generally radial acoustic path.

The audio transducer 3 comprises a diaphragm 4 and a permanent magnet 5. As shown in FIG. 12, the acoustic baffle 2 has an annular configuration and extends around the circumference of the audio transducer 3. The acoustic baffle 2 comprises a plurality of cells 8 each consisting of discrete resonator chambers 9 which function as acoustic resonators for attenuating sound waves transmitted through the acoustic baffle 2. As shown in FIG. 12, the acoustic baffle 2 is multi-layered and comprises three cylindrical layers L1-3 each comprising a plurality of said cells 8. The cells 8 each have a part-cylindrical (arcuate) form and are disposed radially outwardly of the circumference of the diaphragm 4. The layers L1-3 are arranged concentrically about a longitudinal axis X (extending perpendicular to a plane of the page in FIG. 12) such that an outer profile of the acoustic baffle 2 forms a cylinder. The thickness of each layer L1-3 of the acoustic baffle 2 is approximately 5mm (measured along a radius R). The first layer L1 will now be described by way of example.

The cells 8 in the first layer L1 are defined between opposing first and second walls 11, 12. The first and second walls 11, 12 are right cylindrical walls arranged concentrically about the longitudinal axis X. A series of internal walls 13 are formed between the first and second walls 11, 12 to form the cells 8 and the resonator chambers 9. The internal walls 13 comprise radial walls 14 and planar annular walls 15 extending in a plane perpendicular to the longitudinal axis X. The ends of the acoustic baffle 2 are closed by end walls (not shown). As shown in FIG. 13, a plurality of inlet apertures 16 are formed in the first wall 11; and a plurality of outlet apertures 17 are formed in the second wall 12. The inlet and outlet apertures 16, 17 establish an acoustic pathway (illustrated by an arrow A in FIG. 12) for transmission of sound waves through the cells 8. The acoustic pathway is illustrated as a linear path in FIG. 13 (i.e. the inlet apertures 16 are radially aligned with the outlet apertures 17) and extending radially outwardly from the longitudinal axis X. It will be appreciated that the cells 8 could be arranged such that the acoustic path is non-linear (i.e. the inlet apertures 16 can be radially and/or longitudinally offset from the outlet apertures 17).

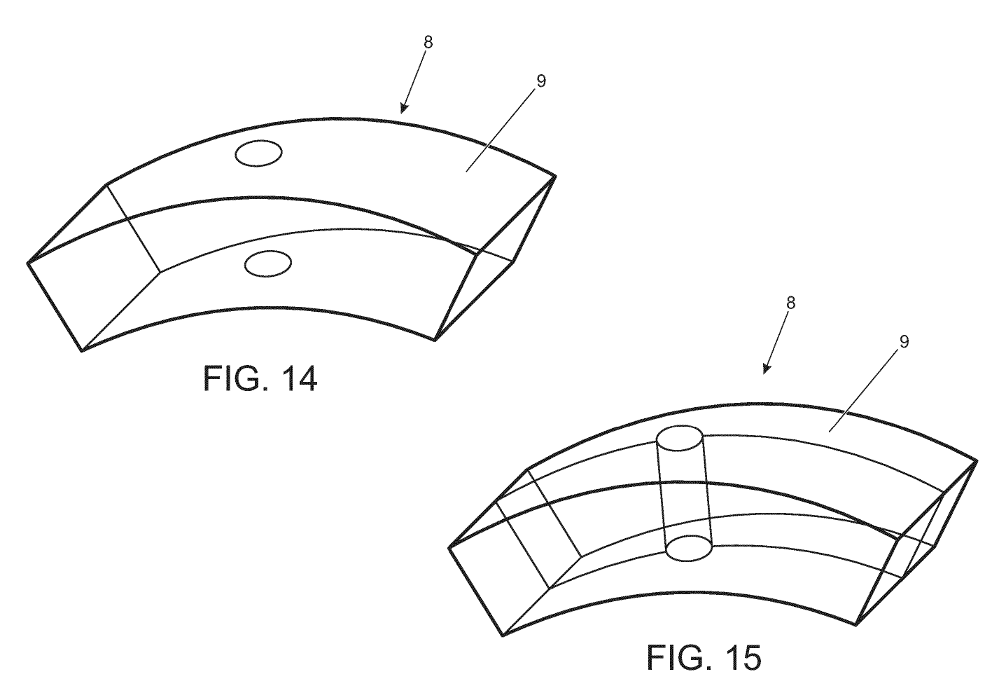

A first alternative of the cell 8 for the second embodiment is shown in FIG. 14. The cell 8 in this arrangement consists of a single resonator chamber 9. A second alternative of the cell 8 for the second embodiment is shown in FIG. 15. The cell 8 in this arrangement consists of two resonator chambers 9.

The resonator chambers 9 can optionally be filled with an acoustic damping material, such as open-cell foam or a nanomaterial.

It will be appreciated that various changes and modifications can be made to the audio transducer assembly 1 described herein without departing from the scope of the present application. The cells 8 arranged in each layer L1-3 can have different configurations, for example to form resonator chambers 9 having different internal volumes in each layer L1-3. The internal volumes of the resonator chambers 9 can progressively increase or decrease along an acoustic pathway formed through the acoustic baffle 2. For example, the internal volume of the resonator chambers 9 can increase or decrease progressively in each layer L1-3 of the acoustic baffle. In an alternative arrangement, the internal volumes of a series of resonator chambers 9 can be the same.

The acoustic baffle 2 has been described in conjunction with an audio transducer 3. However, the acoustic baffle 2 in accordance with the present invention is not limited in this respect and could be used to damp sound from other acoustic sources.

Further aspects of the present invention are set out in the following set of numbered paragraphs:

1. An acoustic baffle for attenuating sound waves generated by an acoustic source, the acoustic baffle comprising:
one or more cells each comprising:
   opposing first and second walls defining at least one resonator chamber for attenuating sound waves generated by the acoustic source;
   the first wall comprising an inlet aperture for ingress of sound waves generated by the acoustic source into the resonator chamber; and
   the second wall comprising an outlet aperture for egress of attenuated sound waves from the resonator chamber.

2. An acoustic baffle as described in paragraph 1, wherein each cell comprises at least one internal wall extending between said first and second walls to define a plurality of said resonator chambers.

3. An acoustic baffle as described in paragraph 2, wherein each cell comprises first and second internal walls angularly offset from each other.

4. An acoustic baffle as described in paragraph 2, wherein each internal wall comprises an opening aligned with said inlet aperture and/or said outlet aperture such that said resonator chambers are in communication with said plurality of said resonator chambers.

5. An acoustic baffle as described in paragraph 1, wherein said inlet aperture and said outlet aperture are aligned with each other.

6. An acoustic baffle as described in paragraph 1, wherein said first and second walls are arranged parallel to each other.

7. An acoustic baffle as described in paragraph 1, wherein said first and second walls are planar walls.

8. An acoustic baffle as described in paragraph 1, wherein said first and second walls are concentric curved walls.

9. An acoustic baffle as described in paragraph 1 comprising a plurality of said cells.

10. An acoustic baffle as described in paragraph 9, wherein the plurality of cells is arranged in one or more layers.

11. An acoustic baffle as described in paragraph 9, wherein each cell has a part-circular form and the cells are arranged to form at least a portion of a cylinder.

12. An acoustic baffle as described in paragraph 9, wherein each cell has a part-conical form and the cells are arranged to form at least a portion of a cone.

13. An acoustic baffle as described in paragraph 9, wherein each cell has a part-spherical form and the cells are arranged to form at least a portion of a sphere.

14. An acoustic baffle as described in paragraph 9 comprising a central axis, wherein the cells are arranged concentrically about said central axis.

15. An acoustic baffle as described in paragraph 14, wherein an internal volume of the cells proximal to the central axis is smaller than the internal volume of the resonating chambers distal from said central axis.

16. An acoustic baffle as claimed described in paragraph 9, wherein the cells are arranged in first and second layers, the first and second layers being contiguous.

17. An acoustic baffle as described in paragraph 16, wherein the outlet of each cell in the first set is coincident with the inlet of each cell in the second set.

18. An acoustic baffle as described in paragraph 16, wherein the outlet of each cell in the first set is offset from the inlet of each cell in the second set.

19. An acoustic baffle as described in paragraph 1, wherein each resonator chamber comprises a sound damping material.

20. An audio transducer assembly comprising an audio transducer and an acoustic baffle as described in paragraph 1, wherein the first wall of the acoustic baffle is arranged to face the audio transducer and the second wall of the acoustic baffle is arranged to face away from the audio transducer.

21. An audio transducer assembly as described in paragraph 20, wherein a cavity is disposed between the audio transducer and the acoustic baffle, the cavity being open to atmosphere through the acoustic baffle.

22. An audio transducer assembly as described in paragraph 20, wherein the audio transducer and the acoustic baffle are arranged coaxially within the audio transducer assembly.

23. An audio transducer assembly as described in paragraph 20, wherein the audio transducer comprises a diaphragm for generating sound waves, the diaphragm having a front face and a back face, wherein the acoustic baffle is disposed behind the audio transducer and the first wall arranged to face the back face of the diaphragm.

24. An audio transducer assembly as described in paragraph 23, wherein the diaphragm and the acoustic baffle have substantially the same outer diameter.

25. A vehicle comprising an acoustic baffle as described in paragraph 1.

1. An acoustic baffle for attenuating sound waves generated by an acoustic source, the acoustic baffle comprising:
a plurality of cells, wherein each cell comprises opposing first and second walls that define at least one resonator chamber for attenuating sound waves generated by the acoustic source, wherein the first wall comprises an inlet aperture for ingress of sound waves generated by the acoustic source into the at least one resonator chamber, and wherein the second wall comprises an outlet aperture for egress of attenuated sound waves from the at least one resonator chamber,
wherein the plurality of cells are arranged concentrically about a central axis of the acoustic baffle, and
wherein an internal volume of the at least one resonator chamber increases with radial distance of the at least one resonator chamber from the central axis.

2. The acoustic baffle as claimed in claim 1, wherein each cell comprises a plurality of resonator chambers as the at least one resonator chamber, and wherein each cell comprises at east one internal wall that is curved or is extending between the first and second wails to define the plurality of resonator chambers.

3. The acoustic baffle as claimed in claim 2, wherein the at least one internal wall comprises first and second internal walls angularly offset from each other, and/or wherein the at least one internal wall comprises an opening aligned with the inlet aperture and/or the outlet aperture such that the plurality of resonator chambers are in communication with each other.

4. (canceled)

5. The acoustic baffle as claimed in claim 1, wherein the inlet aperture and the outlet aperture are aligned with each other.

6. The acoustic baffle as claimed in claim 1, wherein the first and second walls are arranged parallel to each other.

7. The acoustic baffle as claimed in claim 1, wherein the first and second walls are planar walls, or wherein the first and second walls are concentric curved walls.

8-10. (canceled)

11. The acoustic baffle as claimed in claim 1, wherein the plurality of cells is arranged in one or more layers.

12. The acoustic baffle as claimed in claim 1, wherein each cell has a part-circular form and the cells are arranged to form at least a portion of a cylinder, or wherein each cell has a part-conical form and the cells are arranged to form at least a portion of a cone, or wherein each cell has a part-spherical form and the cells arranged to form at least a portion of a sphere.

13-15. (canceled)

16. The acoustic baffle as claimed in claim 1, wherein an internal volume of the resonating chambers proximal to, the central axis is smaller than the internal volume of the resonating chambers distal from the said central axis.

17. The acoustic baffle as claimed in claim 1, wherein the cells are arranged in first and second layers, and wherein the first and second layers are contiguous.

18. The acoustic baffle as claimed in claim 17, wherein the outlet aperture of each cell in the first layer is coincident with the inlet aperture of each cell in the second layer.

19. The acoustic baffle as claimed in claim 17, wherein the outlet aperture of each cell in the first layer is offset from the inlet aperture of each cell in the second layer set.

20. The acoustic baffle as claimed in claim 1, wherein each resonator chamber comprises a sound damping material.

21. An audio transducer assembly, comprising:
an audio transducer; and
the acoustic baffle as claimed in claim 1, wherein the first wall of the acoustic baffle is arranged to face the audio transducer and the second wall of the acoustic baffle is arranged to face away from the audio transducer.

22. The audio transducer assembly as claimed in claim 21, wherein a cavity is disposed between the audio transducer and the acoustic baffle, wherein the cavity is open to atmosphere through the acoustic baffle.

23. The audio transducer assembly as claimed in claim 21, wherein the audio transducer and the acoustic baffle are arranged coaxially within the audio transducer assembly.

24. The audio transducer assembly as claimed in claim 21, wherein the audio transducer comprises a diaphragm for generating sound waves, the diaphragm having a front face and a back face, wherein the acoustic baffle is disposed behind the audio transducer, and wherein the first wall is arranged to face the back face of the diaphragm.

25. The audio transducer assembly as claimed in claim 24, wherein a diameter of the diaphragm and a diameter of the acoustic baffle are substantially the same.

26. A vehicle comprising the acoustic baffle as claimed in claim 1.

27-28. (canceled)

29. The acoustic baffle as claimed in claim 1, wherein the at least one resonator chamber of each cell comprises a plurality of resonator chambers, and wherein at least two of the plurality of resonator chambers are tuned to different frequencies.
